(19) United States
(12) Patent Application Publication
(10) Pub. No.: US 2007/0174539 A1
(43) Pub. Date: Jul. 26, 2007

(54) System and method for restricting the number of object copies in an object based storage system

(76) Inventors: Hidehisa Shitomi, Mountain View, CA (US); Manabu Kitamura, Cupertino, CA (US)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/320,857

(22) Filed: Dec. 30, 2005

(51) Int. Cl. G06F 12/00

(52) U.S. Cl. 711/100

(57) ABSTRACT

System and method for restricting the number of times the objects may be copied in an object based storage system. A command is generated by a host device that sets a copy limit for an object at the storage system. An OSD command is generated at the storage system that sets a copy limitation flag attribute and a copy limit attribute of the object. Updating the value of the copy limitation attribute of an object during a copy pair creation operation includes: starting an initial copy of objects from a source LU to a destination LU if neither of the logical units are used for the other copy pair, reading each object in the source LU, decrementing by one a copy limit value of each object, sending each object to a second processor module at a remote site, and writing each object at the second processor module to the destination LU.

### BACKGROUND

1. Field of the Invention

This invention relates to object based storage systems, and more specifically to restricting the number of times the object may be copied in an object based storage system.

2. Description of the Related Art

A storage device (e.g., magnetic disks) typically stores data on a block basis. However, a storage device that stores data as an object is called an OSD (Object-Based Storage Device). In an OSD, each object includes the data and an attribute portion. The attributes may include information regarding, for example, the size of the data, user ID information, etc. Since the attribute information maintains the size of data in the object, the object size may be variable.

A copy mechanism provided by a storage system such as remote copy, local copy, and snapshot becomes an important technology for a business in order to insure business continuity and data protection. Moreover, in current storage systems it is possible to make an infinite number of object copies, even if there is a license agreement of copy restriction.

Therefore, there is a need to restrict the number of copies of objects in an object based storage system.

### SUMMARY OF THE INVENTION

A system and method for restricting the number of times the object may be copied in an object based storage system. A command is generated by a host device that sets copy limit attributes for an object at the storage system. An OSD command is generated at the storage system that sets an attribute of the object containing the value of copy limit of the object. The value of the attribute is then set to the object. Updating the value of copy limitation of an object during a copy pair creation operation includes: starting an initial copy of objects from a source logical unit (LU) to a destination LU if neither of the logical units are associated with another copy pair, reading each object in the source LU, decrementing by one, by the first processor module, a copy limit number of each object, sending each object to a second processor module at a remote site, and writing each object to the destination LU. The present invention may also be applied to any other unit of storage other than an object such as, for example, a unit of storage including each object in a logical unit (i.e., an entire LU). Moreover, the decrementing may occur at either the storage system, the remote site, or at both locations.

### BRIEF DESCRIPTION OF THE DRAWINGS

The present invention is further described in the detailed description which follows in reference to the noted plurality of drawings by way of non-limiting examples of embodiments of the present invention in which like reference numerals represent similar parts throughout the several views of the drawings and wherein:

FIG. 1 is a diagram of an example hardware configuration of an object-based storage system according to an example embodiment of the present invention;

FIG. 2 is a diagram of an example software configuration of a storage system according to an example embodiment of the present invention;

FIG. 3 is a diagram of an OSD Logical Unit according to an example embodiment of the present invention;

FIG. 4 is a diagram of an object according to an example embodiment of the present invention;

FIG. 5 is a list of some OSD operations/commands according to an example embodiment of the present invention;

FIG. 6 is a diagram of a system for setting a copy limitation to a specific object, according to an example embodiment of the present invention;

FIG. 7 is a flowchart of a control flow process that can be implemented in the system of FIG. 6 according to an example embodiment of the present invention;

FIG. 8 is a diagram of a system for remote copy pair creation functionality with object copy limitation according to an example embodiment of the present invention;

FIG. 9 is a diagram of a copy management table according to an example embodiment of the present invention;

FIG. 10 is a diagram of an object management table according to an example embodiment of the present invention;

FIGS. 11 and 12 are a flowchart of a copy pair creation operation according to an example embodiment of the present invention;

FIG. 13 is a diagram of a system where the copy limitation is done after the copy pair creation according to an example embodiment of the present invention;

FIG. 14 is a flowchart of an operation where the copy limitation is performed after a copy pair creation according to an example embodiment of the present invention;

FIG. 15 is a diagram of a system for restricting an access to a copied object on a remote storage system by using the copy limit attribute according to an example embodiment of the present invention;

FIG. 16 is a flowchart of a process for restricting an access to a copied object on a remote storage system by using a copy limit attribute according to an example embodiment of the present invention;

FIG. 17 is a diagram of a system for restricting a copy from copied objects according to an example embodiment of the present invention;

FIG. 18 is a flowchart for a process for restricting a copy from copied objects according to an example embodiment of the present invention;

FIG. 19 is a diagram of a system for object level recovery according to an example embodiment of the present invention;

FIG. 20 is a flowchart of a process for object level recovery according to an example embodiment of the present invention;

FIG. 21 is a diagram of a system for a logical unit level recovery according to an example embodiment of the present invention;

FIG. 22 is a flowchart of a process for logical unit level recovery according to an example embodiment of the present invention;

FIG. 23 is a diagram of a system for object level remote copy pair creation according to an example embodiment of the present invention;

FIGS. 24 and 25 are a flowchart of a process for object level remote copy pair creation according to an example embodiment of the present invention;

FIG. 26 is a diagram of an object level copy management table according to an example embodiment of the present invention;

FIG. 27 is a diagram of a system for logical unit level copy limitation setting according to an example embodiment of the present invention; and

FIG. 28 is a flowchart of a process for logical unit level copy limitation setting according to an example embodiment of the present invention.

### DETAILED DESCRIPTION

The particulars shown herein are by way of example and for purposes of illustrative discussion of the embodiments of the present invention. The description taken with the drawings make it apparent to those skilled in the art how the present invention may be embodied in practice.

Further, arrangements may be shown in block diagram form in order to avoid obscuring the invention, and also in view of the fact that specifics with respect to implementation of such block diagram arrangements is highly dependent upon the platform within which the present invention is to be implemented, i.e., specifics should be well within purview of one skilled in the art. Where specific details (e.g., circuits, flowcharts) are set forth in order to describe example embodiments of the invention, it should be apparent to one skilled in the art that the invention can be practiced without these specific details. Finally, it should be apparent that any combination of hard-wired circuitry and software instructions can be used to implement embodiments of the present invention, i.e., the present invention is not limited to any specific combination of hardware circuitry and software instructions.

Although example embodiments of the present invention may be described using an example system block diagram in an example host unit environment, practice of the invention is not limited thereto, i.e., the invention may be able to be practiced with other types of systems, and in other types of environments.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

According to embodiments of the present invention, the number of times the object may be copied in an object based storage system is restricted (e.g., to insure compliance with a license agreement). This functionality is provided using a new attribute with an object. Further, the object based storage system provides an interface to set the attribute. Embodiments of the present invention also include mechanisms to do a remote copy based on the object storage system. An object based storage system according to the present invention provides an interface for object based remote copy especially for copy restricting objects. Moreover, the storage system employs a mechanism to restrict the access to or copy from a copied object, and can also recover a copy restricted object.

System and method embodiments according to the present invention for restricting the number of times the object may be copied in an object based storage system provide: an object with attributes for the copy limitation flag and the acceptable number of copies; a storage interface to set the copy limitation flag and the acceptable number of object copies; a storage interface of remote copy on an object storage; a process of remote copy in an object storage; manipulating the copy limit attribute, copy operations (READ and CREATE_WRITE); a process of blocking read access to a copied object and copy from a copied object, checking the copy limit attribute at read/copy; and a process and interface of recovering the copied object, manipulating the copy limit attribute. These features will be discussed in more detail following.

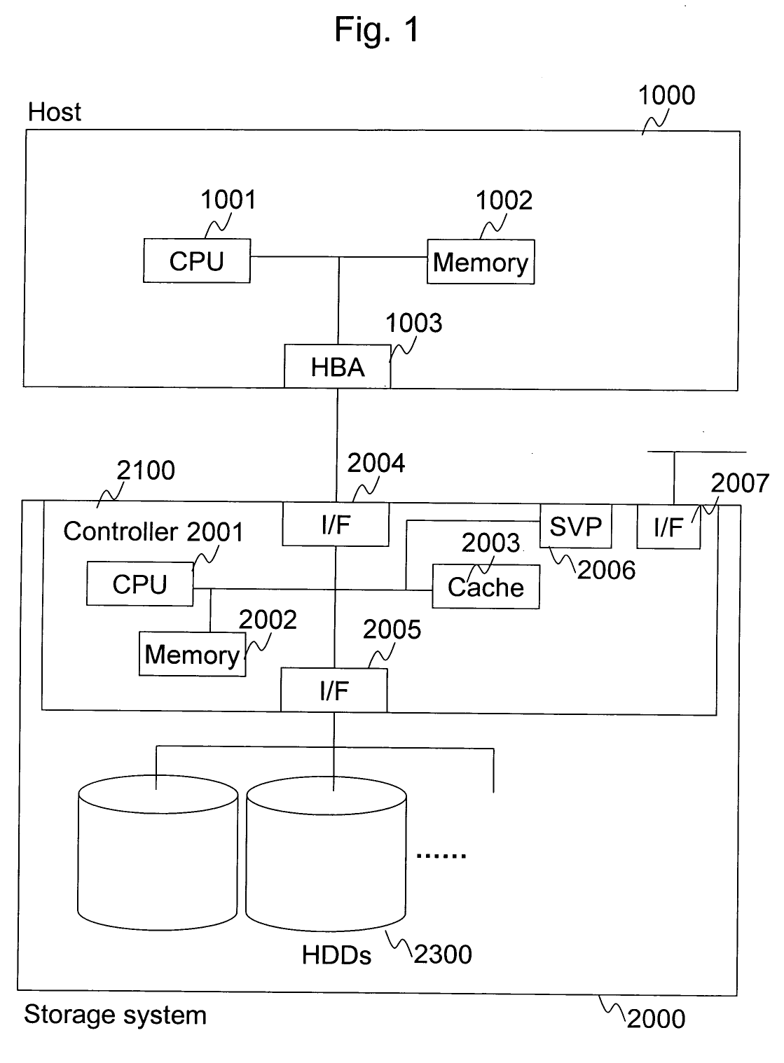

FIG. 1 shows a diagram of an example hardware configuration of an object-based storage system according to an example embodiment of the present invention. The system may include a host computer 1000 operatively connected to a storage system 2000 via a host bus adapter (HBA) 1003 at the host computer 1000 and a host interface 2004 at storage system 2000. The host computer 1000 may include a CPU 1001, a memory 1002, and a host bus adapter 1003. The storage system 2000 may include a disk controller 2100 that includes a CPU 2001, a memory 2002, a cache memory 2003, the host interface 2004, a disk interface 2005, and a service processor (SVP) 2006, an interface for a remote copy 2007, and one or more HDDs 2300. The devices within the disk controller 2100 may all be interconnected via an internal bus. The disk controller 2100 processes input/output (I/O) requests from the host computer 1000. The I/O request is based on the object-based storage device commands and SCSI commands.

The interface between the host computer 1000 and the storage system 2000 may be a fibre channel (FC), Ethernet, etc. The disk interface 2005 is used to connect the HDDs 2300 and the disk controller 2100. The service processor 2006 may be operatively connected to the storage system 2000, and used to set/change the configuration of the storage system 2000.

The memory 2002 may be used to store programs to process I/O requests or other operations. The CPU 2001 executes the programs stored in the memory 2002. The cache memory 2003 may store the write data from the host computer 1000 temporarily before the data is stored into the storage devices 2200, and may also store the read data that is requested by the host computer 1000. The cache memory 2003 may be a battery backed-up non-volatile memory. Further, the memory 2002 and the cache memory 2003 may be combined within the same memory and still be within the scope of the present invention.

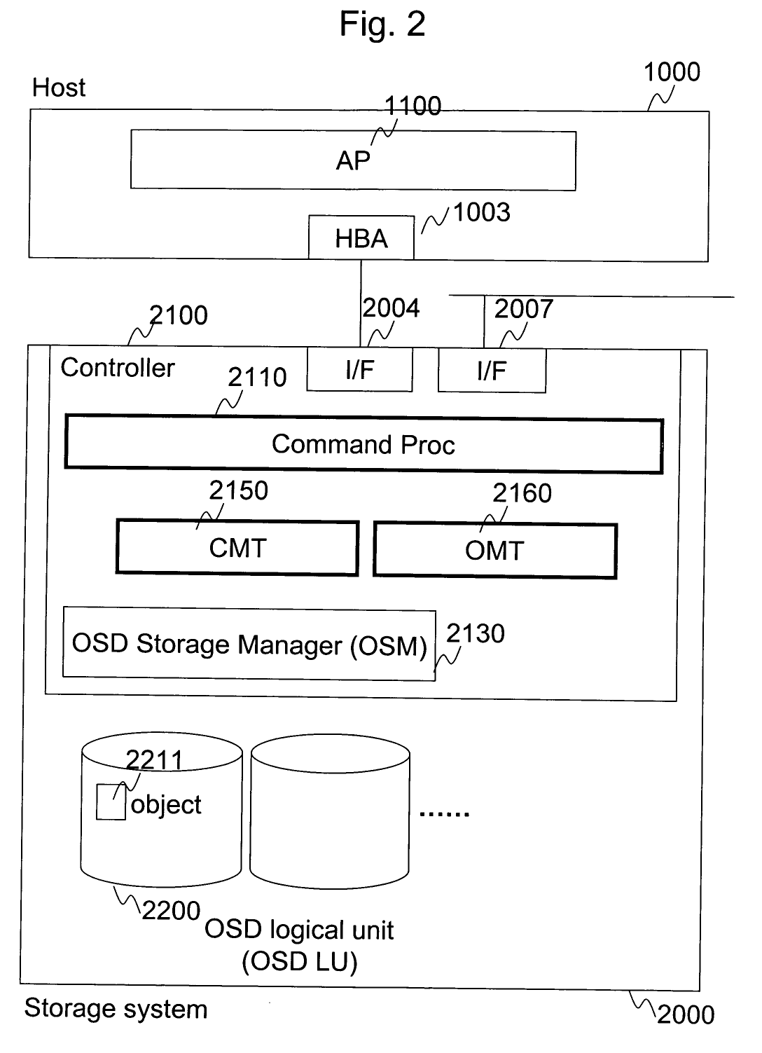

FIG. 2 shows a diagram of an example software configuration of a storage system according to an example embodiment of the present invention. A host 1000 may be a server computer of a client-server system, a main frame computer, or any other type computer on which some application (AP) 1100 is executed causing the host 1000 to issue I/O commands to a storage system 2000 through an interface 1003. The storage system 2000 may include a disk controller 2100 and a number of OSD Logical Units (OSD LUs) 2200. The disk controller 2100 includes a command processor module 2110 running on the CPU 2001 that receives both SCSI and OSD commands from a host 1000, and processes SCSI commands and sends OSD commands to an OSD Storage Management (OSM) module 2130. A copy management table 2150 may be maintained by the command processor module 2110 on the storage system 2000 stores the copy pair information. An object management table 2160 may be used by the command processor module 2110 to manage Partition Identifiers (PIDs) and Object Identifiers (OIDs) in an OSD logical unit (LU). There may be one or more OSD LUs in a storage system 2000. The OSD Storage Management module 2130 is a program running on the CPU 2001 that processes OSD commands and manages the physical location of objects (mapping from PID, OID to LBA). It may reside on a disk controller 2100. An object can be associated with a file and other computational components.

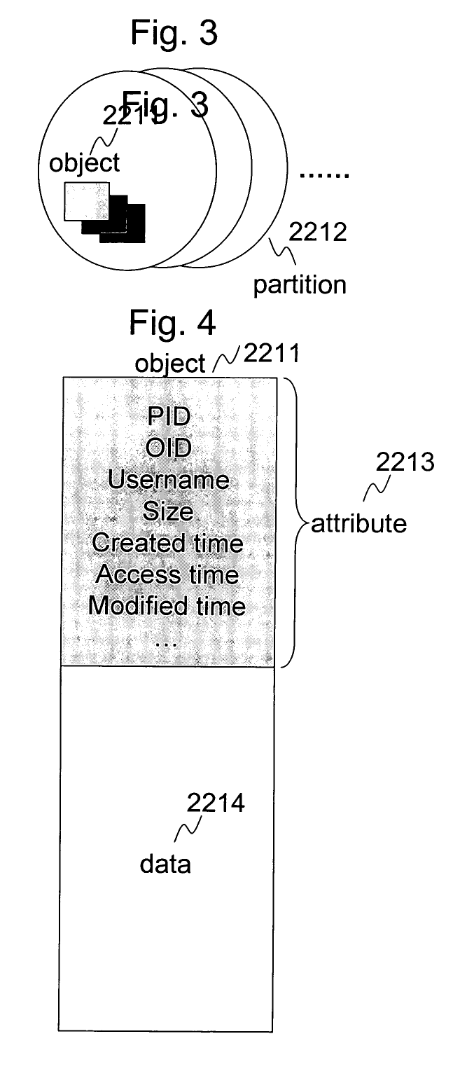

FIG. 3 shows a diagram of an OSD LU according to an example embodiment of the present invention. There may be one or more partitions 2212 in an OSD LU. Moreover, these LUs may include one or more objects 2211 within a partition 2212. In a partition, objects can share attributes.

FIG. 4 shows a diagram of an object according to an example embodiment of the present invention. The object 2211 includes the “data” 2214 and an “attribute” (metadata) 2213. Since the size of an object may be variable, each object may include the size of the object in each attribute. An object 2211 may maintain any type of attribute information such as, for example, partition ID (PID), object ID (OID) that is the identification number of each object, user name that identifies the user name of the object, used capacity that shows the size of the object (including attribute), created time that is the time that the object was created, attribute accessed time that is the last time that the attribute was accessed, attribute modified time that is the last time that the attribute was modified, data accessed time that is the time the data was accessed, and data modified time that is the last time the data was modified. Some attribute information has already been defined in standardization organizations, but vendors may also define additional attribute information in their OSDs. Moreover, although there may be existing OSD commands, vendors may define unique parameters used in these existing OSD commands, or may define proprietary OSD commands based on specific OSD implementations.

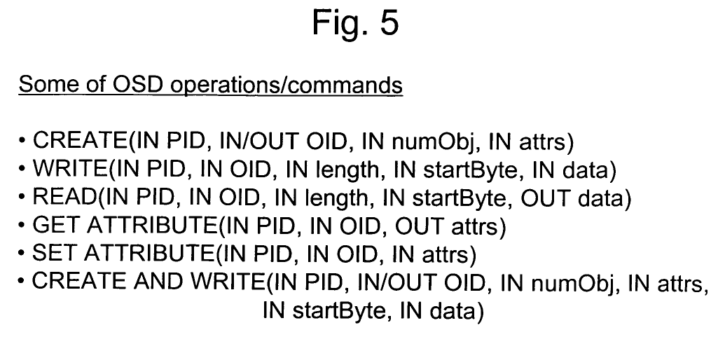

FIG. 5 shows a list of some OSD operations/commands according to an example embodiment of the present invention. These operations/commands include, for example, CREATE, WRITE, READ, SET ATTRIBUTE, GET ATTRIBUTE, and CREATE AND WRITE. The CREATE command is used to allocate one or more objects in the OSD. The WRITE command includes parameters related to the object ID, starting byte address, and length. This command is used for writing a certain length of data from the specified starting byte address and the object specified within the object ID. Further, the attribute can be changed at the same time when invoking the command. The READ command includes parameters related to the object ID, starting byte address, and length. This command is used for reading a certain length of data from the specified starting byte address and the object specified with the object ID. Further, the object can be changed at the same time when invoking the command. The SET ATTRIBUTE command may be used to change an attribute of an object specified in a parameter. The GET ATTRIBUTE command may be used to retrieve an attribute of an object specified in a parameter from an object-based storage device. The CREATE AND WRITE command is a combination operation of a create operation and write operation and is used to execute create and write operations in a single command.

According to embodiments of the present invention, to restrict the number of allowable copies, a “copy_limit” attribute and a “copy_limit_flag”0 attribute are used. These attributes may be vendor specific attributes. The copy_limit_flag attribute can be a binary value, indicating whether or not an object is restricted to a certain number of copies being generated. Moreover, the copy_limit attribute can be a numeral, representing the acceptable number of copies of the object that may be generated.

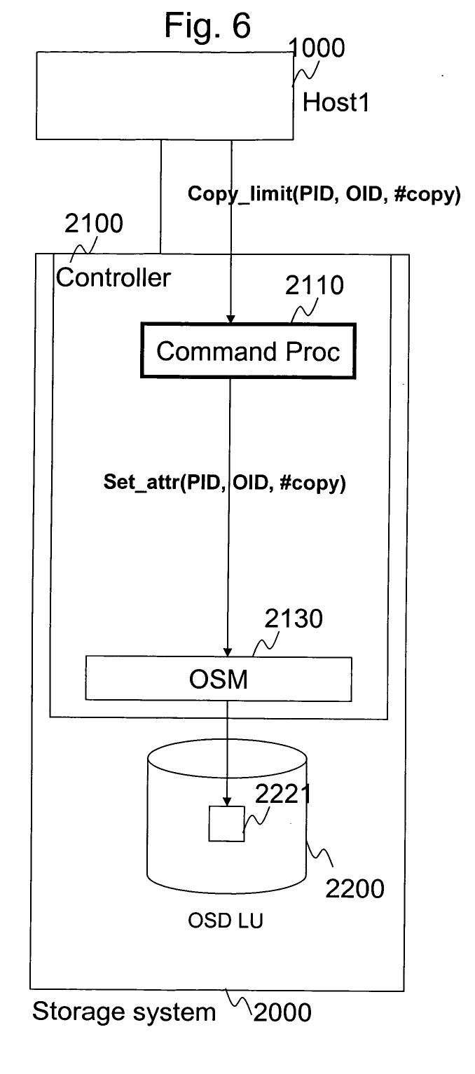

FIG. 6 shows a diagram of a system for setting a copy limitation to a specific object, according to an example embodiment of the present invention. The system may include a host device 1000 operatively connected to a storage system 2000. The storage system 2000 may include a controller 2100, a command processor module 2110, an OSD LU 2200, and an OSD Storage Manager (OSM) 2130. To set the value of the copy_limit attribute of an object, the object storage system 2000 provides a “copy_limit” command whose parameters are the designated object's PID and OID, and the number of copies. At the same time, the value of the copy_limit_flag is set to be “ON”, denoting that the number of copies of the object that can be generated is restricted. The default value of the copy_limit_flag is “OFF”.

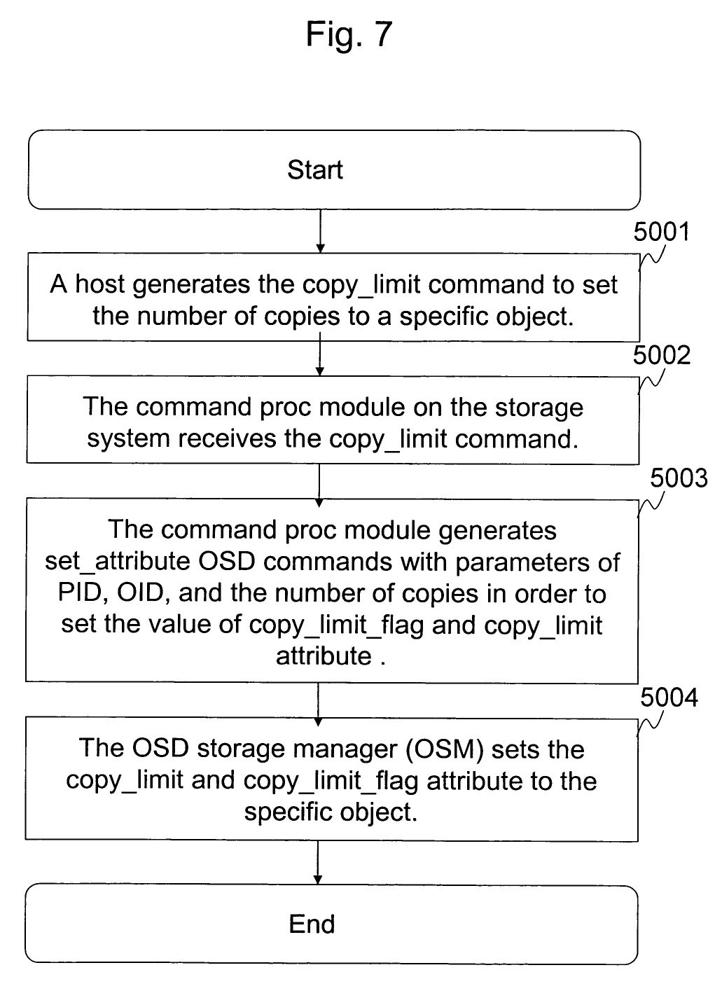

FIG. 7 shows a flowchart of a control flow process that can be implemented in the system of FIG. 6 according to an example embodiment of the present invention. A host 1000 issues the copy_limit command to set the number of copies to a specific object (5001). The command processor module 2110 on the storage system 2000 receives the copy_limit command (5002). The command processor module 2110 then generates set_attribute OSD commands with parameters of PID, OID, and the number of copies in order to set the copy_limit_flag attribute and the value of the copy_limit attribute (5003). The OSM 2130 then processes the OSD command and sets the copy_limit attribute and the copy limit flag attribute to the specific object (5004).

In another example embodiment, the host 1000 may directly issue the set_attribute commands without using the copy_limit command provided by the storage system 2000. In this case, the command processor module 2110 just passes the OSD command to the OSM module 2130. In this embodiment, since the copy limit operation is used with the storage based copy command, such as a remote copy, preferably the copy limitation functionalities or the layer of copy limitation abstraction are provided by the storage system. In this situation, the copy limitation functionality is controlled by the storage system, instead of individual users. Further, in another embodiment, the copy limitation setting can be specified to a whole OSD LU, as will be explained following.

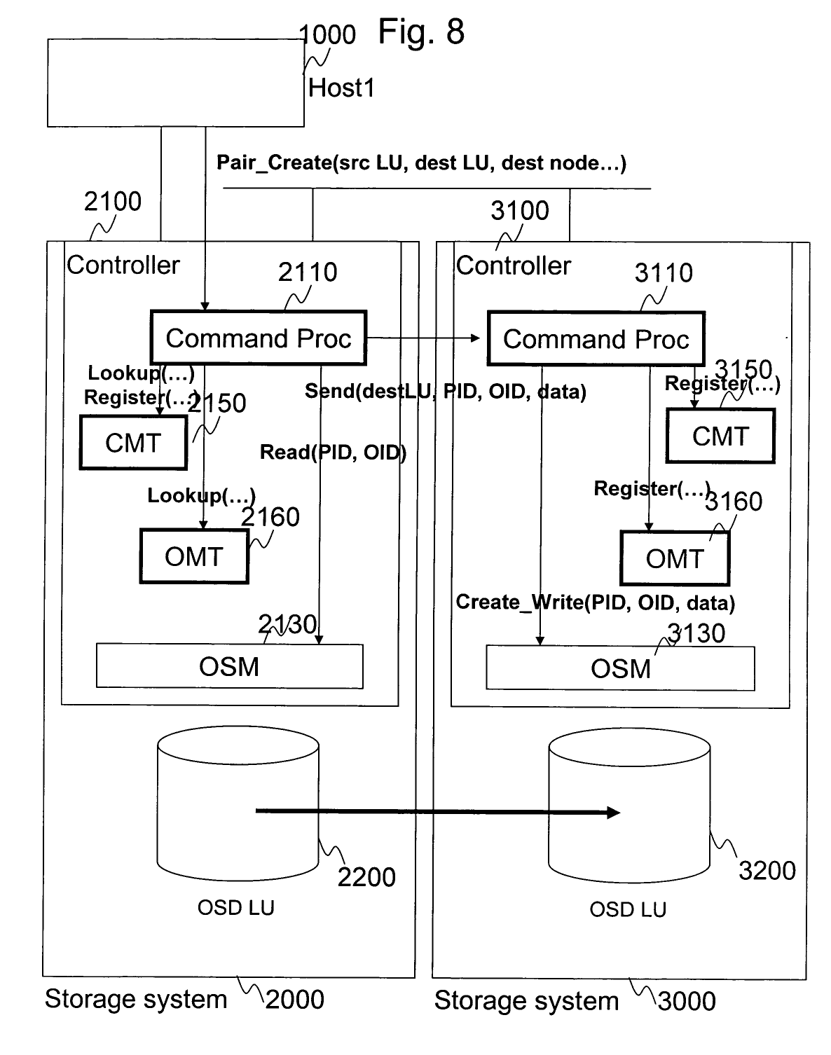

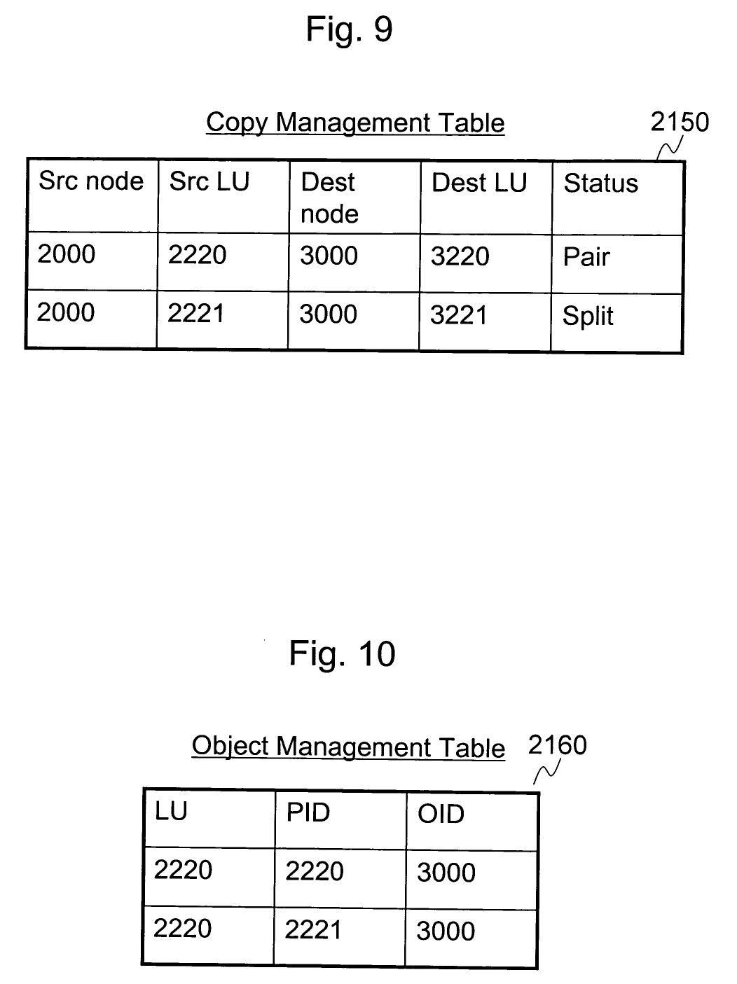

FIG. 8 shows a diagram of a system for remote copy pair creation functionality with object copy limitation according to an example embodiment of the present invention. The system may include one or more host devices 1000, a first storage system 2000, and a second storage system 3000. The first storage system 2000 includes a controller 2100 that includes a command processor module 2110, a copy management table 2150 depicted in FIG. 9, and an object management table 2160 depicted in FIG. 10. The storage system 2000 also includes one or more OSD logical units 2200, and an OSD storage manager (OSM) 2130. The second storage system 3000 is similarly structured and includes a controller 3100 that includes a command processor module 3110, a copy management table 3150, and an object management table 3160. The storage system 3000 also includes one or more OSD logical units 3200, and an OSM 3130. The command processor module 2110 of the first storage system 2000 receives and operates commands from the host device 1000. The host device 1000 may send a Pair_Create command to the storage system 2000 containing appropriate parameters such as source logical unit (srcLU), destination logical unit (destLU), destination node address, etc. The first storage system 2000 and the second storage system 3000 may be interconnected through their respective controllers 2100, 3100, via a network.

FIG. 9 shows a diagram of a copy management table 2150 according to an example embodiment of the present invention. The copy management table 2150 may be maintained by a controller 2100 and used by the command processor module 2110 on the storage system 2000 to determine if either of the logical units is associated with another remote copy pair, after receiving a pair create command. The copy management table 2150 includes information related to the source node, source logical unit, destination node, destination logical unit, and status (e.g., pair, split).

FIG. 10 shows a diagram of an object management table 2160 according to an example embodiment of the present invention. The object management table 2160 may be used by the command processor module 2110 to manage PIDs and OlDs in an OSD logical unit. Then, the table 2160 may include information related to OSD logical unit, partition ID, and object ID. And the information is registered when objects are created in some LU.

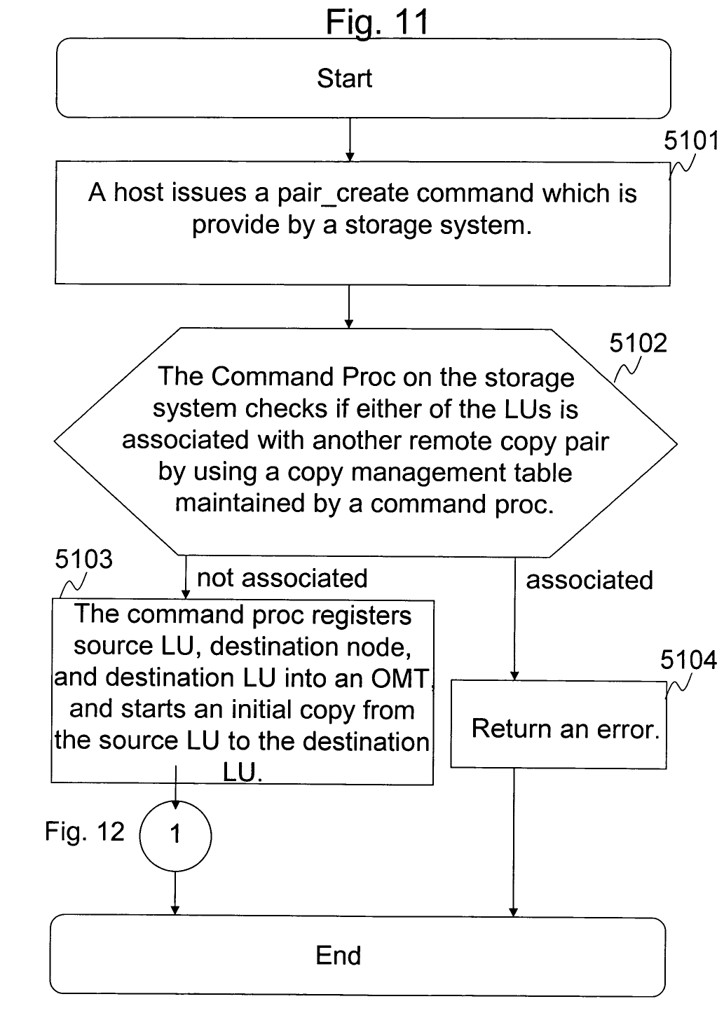

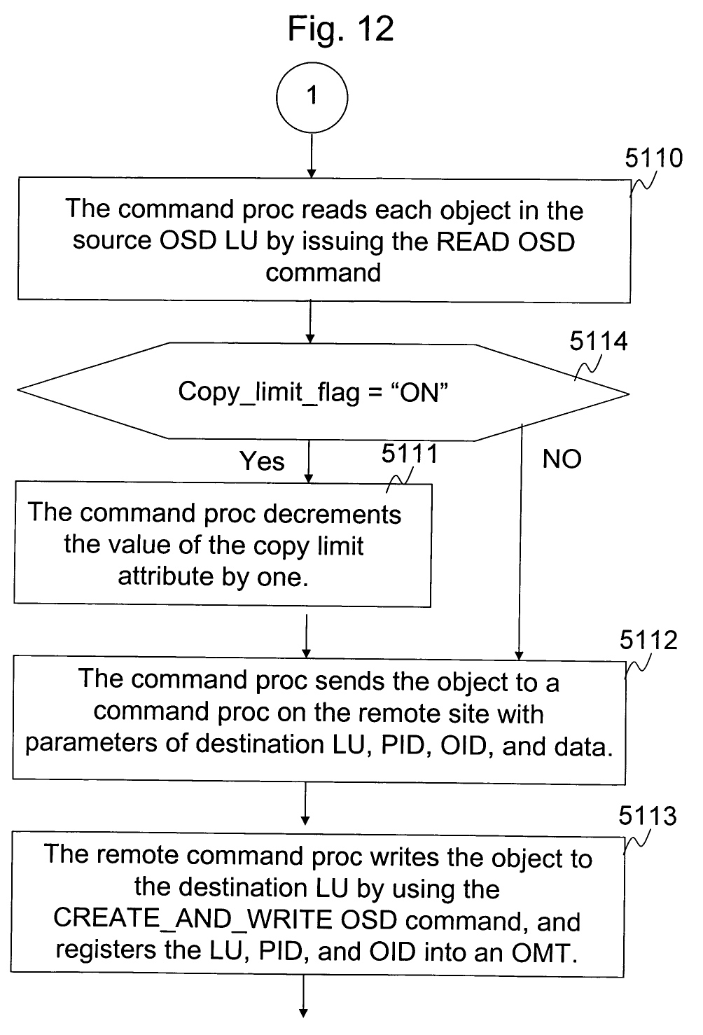

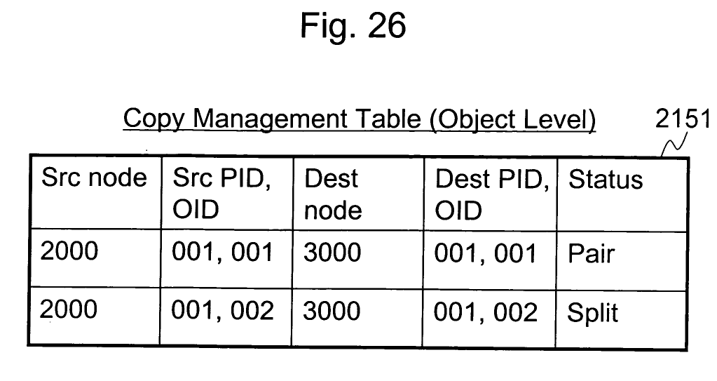

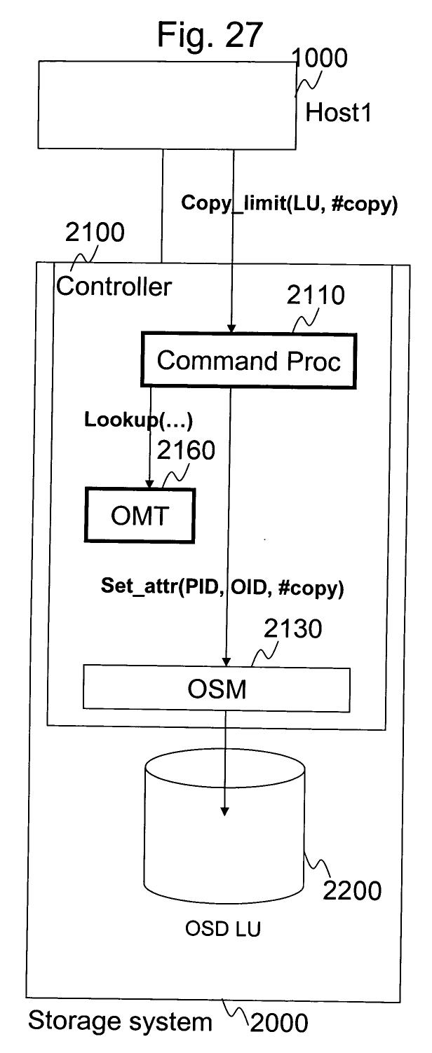

FIGS. 11 and 12 show a flowchart of a copy pair creation operation with object copy limitation according to an example embodiment of the present invention. A host, which can be the same as a node generates IOs, or a management host, which can be different from a node generates IOs, 1000 issues a pair_create command which is provided by a storage system 2000 in order to create a remote copy pair (5101). Typical parameters of the pair_command may include a source logical unit (e.g., OSD LU 2220), destination node address (e.g., storage system 3000), and a destination logical unit (e.g., OSD LU 3220). In the case of an object based storage system, the LU means the OSD LU. When the command processor module 2110 on the storage system 2000 receives the pair_command, it checks to determine if either of the LUs are associated with another remote copy pair by using a copy management table 2150 as discussed previously in FIG. 9, maintained by a controller 2100 (5102). If either of the logical units have another association, an error message is returned to the host (5104). If the logical units are not associated with another remote copy pair, the command processor module 2110 registers the source node, source LU, destination node, destination LU, and status (as Pair) into the copy management table, and starts an initial copy from the source logical unit to the destination logical unit (5103). The copy of the logical unit is done by the unit of object in the logical unit. The command processor module 2110 on the storage controller 2100 can manage object IDs in a logical unit (e.g., FIG. 10). The object management table 2160 can be located in an external metadata server. The command processor module 2110 reads each object in the source OSD logical unit by issuing a read OSD command (5110), and decrements the value of the copy_limit attribute by one if the copy_limit_flag is “ON” (5111), and then sends the object to a command processor module 3110 at the remote site (i.e., second or remote storage system 3000) with parameters of destination LU, PID, OID, and data (5112). The remote command processor module 3110 at the second storage system 3000 writes the object to the destination LU by using the create_and_write OSD command and registers the LU, PID, and OID into an object management table 2160 as discussed previously in FIG. 10 maintained by a command processor 3110 (5113). Moreover, the command processor 3110 can register the copy information into the copy management table 3150 if the transferred message from the storage system 2000 includes parameters of source node address and source LU. The OID are not necessarily sent to the remote site in 5112. In this case, the OID are generated by the OSD storage manager (OSM) 3130 when the OSM receives the create_and_write OSD command, and then the command processor 3110 gets back the OID from OSM and registers the destination LU, PID, and OID into an object management table 3160 maintained by the command processor 3110, and also command processor 3110 registers the source and destination object mapping into some table such as an object level copy management table depicted in FIG. 26. The read, send and write operations can be aggregated, therefore, making it possible to read multiple objects, send multiple objects and write multiple objects.

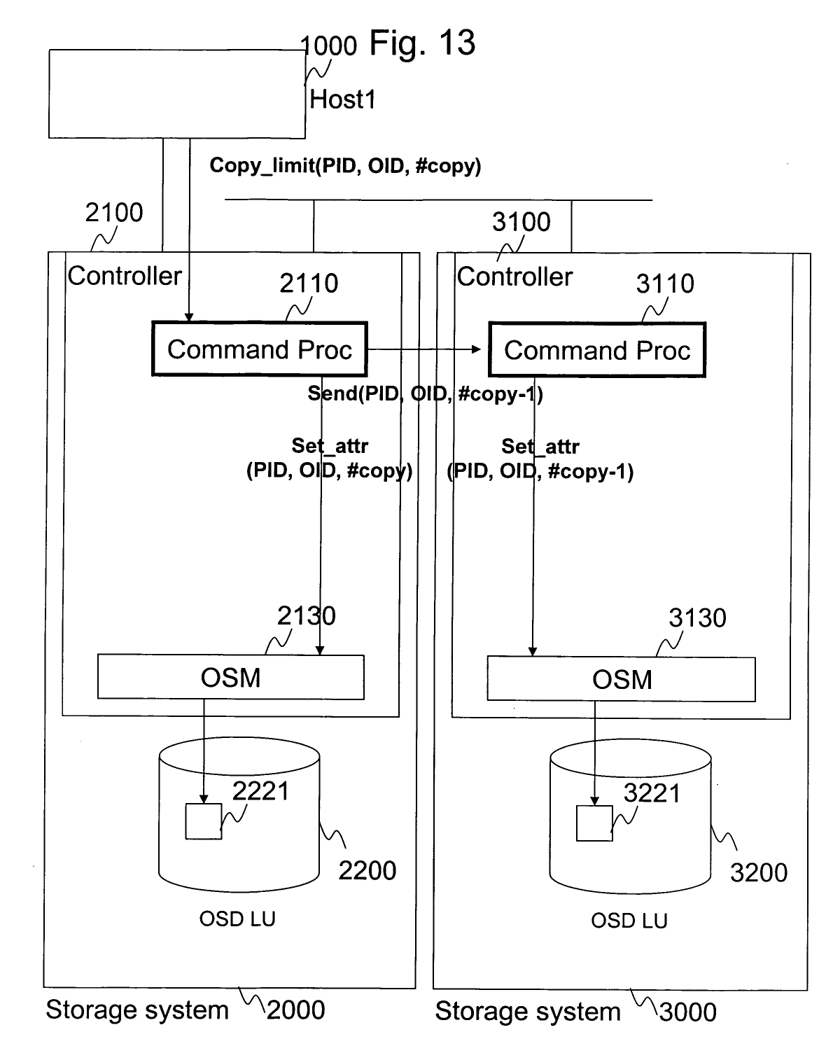

FIG. 13 shows a diagram of a system where the copy limitation is done after the copy pair creation according to an example embodiment of the present invention. The system may include one or more hosts 1000, a first storage system 2000, and a second or remote storage system 3000. The first storage system 2000 includes a controller 2100 that includes a command processor module 2110. The storage system 2000 also includes one or more OSD logical units 2200, and an OSD storage manager (OSM) 2130. The OSD LUs 2200 may include one or more objects 2221. The second storage system 3000 is similarly structured and includes a controller 3100 that includes a command processor module 3110. The storage system 3000 also includes one or more OSD logical units 3200, and an OSM 3130. The OSD LU 3200 may include one or more objects 3221. The command processor module 2110 of the first storage system 2000 receives and operates commands from the host device 1000 (e.g., copy_limit command containing parameters of PID, OID, and number of copies). The first storage system 2000 and the second storage system 3000 may be interconnected through their respective controllers 2100, 3100, via a network.

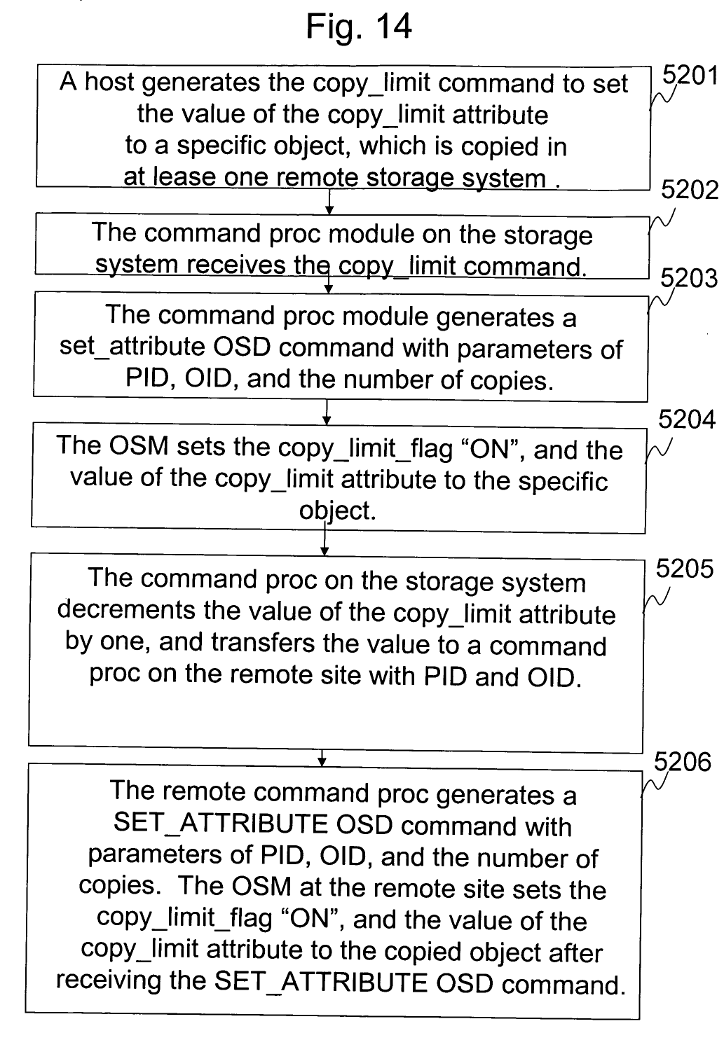

FIG. 14 shows a flowchart of an operation where the copy limitation is performed after a copy pair creation according to an example embodiment of the present invention. A host 1000 generates a copy_limit command to set the value of the copy_limit attribute to a specific object, which is copied in at lease one remote storage system, which means the object is located on the LU which has been paired with a destination LU (5201). The command processor module 2110 on the first storage system 2000 receives the copy_limit command (5202), and then generates a set_attribute OSD command with parameters of PID, OID, and the number of copies (5203). The OSD storage manager (OSM) 2130 sets the copy_limit_“ON” and the value of the copy_limit attribute to the specific object (5204). The command processor module 2110 on the first storage system 2000 decrements the value of the copy_limit attribute by one, and transfers the value with PID and OID to a remote command processor module 3110 on the remote site (second storage system 3000) (5205). The remote command processor 3110 generates a set_attribute OSD command with parameters of PID, OID, and the number of copies. The OSM 3130 at the remote site 3000 sets the copy_limit_flag “ON” and the value of the copy_limit attribute to the copied object 3221 after receiving the set_attribute OSD command (5206). Here we assume the destination PID and OID are the same as the source PID and OID. If the destination PID and OID are different, we need to use the object level copy management table depicted in FIG. 26 to find the destination PID and OID.

If the remote command processor module 3110 found another copy pair for the copied object 3221, the remote command processor module 3110 on the remote site 3000 decrements by one the value of the copy_limit attribute of the another copy pair object, and transfers the value with PID and OID to a third command processor module on a third site (third storage system). The third command processor generates a set_attribute OSD command with parameters of PID, OID, and the number of copies. The OSM at the third site sets the copy_limit_flag “ON” and the value of the copy_limit attribute to the another copy pair object.

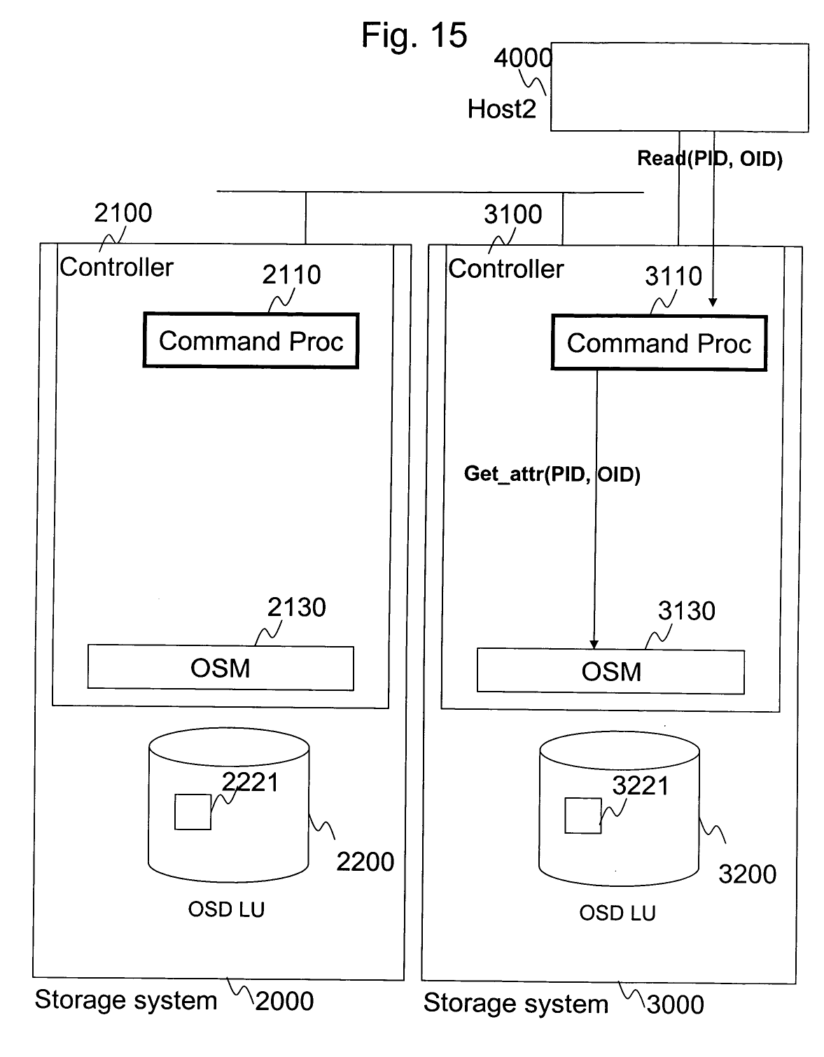

FIG. 15 shows a diagram of a system for restricting an access to a copied object on a remote storage system by using the copy limit attribute according to an example embodiment of the present invention. The system may include a first storage system 2000, and a second or remote storage system 3000. The first storage system 2000 includes a controller 2100 that includes a command processor module 2110. The storage system 2000 also includes one or more OSD logical units 2200, and an OSD storage manager (OSM)2130. The OSD LU 2200 may include one or more objects 2221. The second storage system 3000 is similarly structured and includes a controller 3100 that includes a command processor module 3110. The second storage system 3000 also includes one or more OSD logical units 3200, and an OSM 3130. The OSD LU 3200 may include one or more objects 3221. This system architecture is similar to that shown previously in FIG. 13 except that it includes a second host device 4000 operatively connected to the remote storage system 3000. The command processor module 3110 of the remote storage system 3000 receives and operates commands (e.g., Read command containing parameters of PID and OID) from the host device 4000. The first storage system 2000 and the second storage system 3000 may be interconnected through their respective controllers 2100, 3100, via a network.

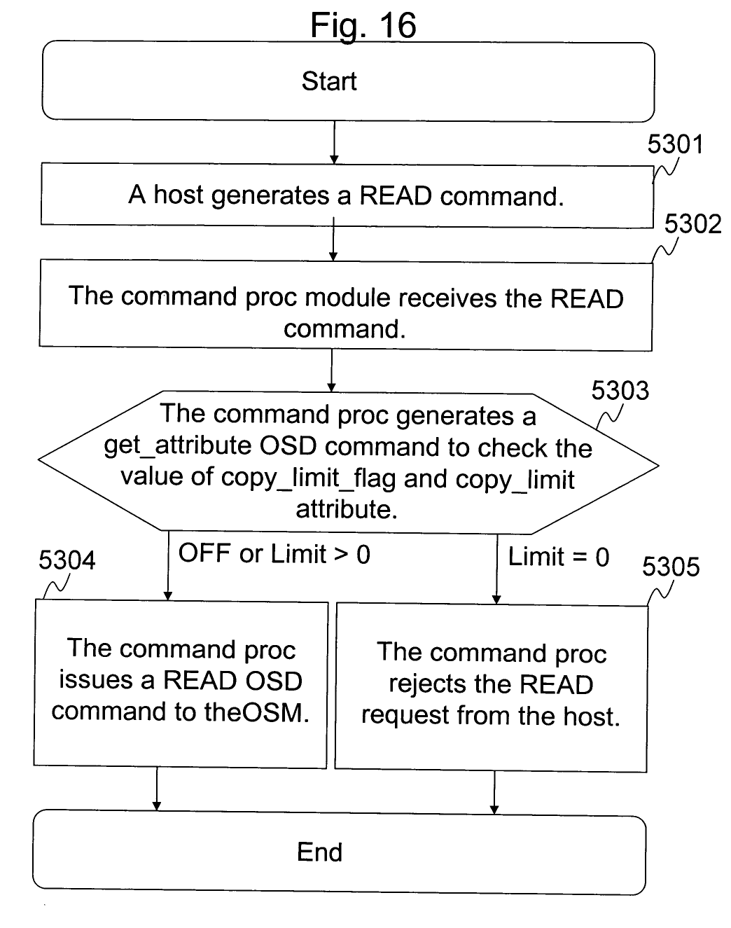

FIG. 16 shows a flowchart of a process for restricting an access to a copied object on a remote storage system by using a copy limit attribute according to an example embodiment of the present invention. A host 4000 generates a read OSD command or read command provided by a storage system 3000 (5301). The command processor module 3110 at the remote storage system 3000 receives the read command (5302). Before forwarding the read OSD command, the command processor module 3110 then generates a get_attribute OSD command to check the value of the copy_limit_attribute and the copy_limit attribute (5303). If the copy_limit_is “OFF” or the value of the copy_limit attribute is more than 0, the command processor module 3110 issues or forward a read OSD command to the OSM 2130 (5304). If the value of the copy_limit attribute is 0, the command processor module 3110 rejects the read request from the host 4000 (5305).

There are other possibilities to control the access to the copied object. In another example embodiment of the present invention, access to the copied object is always allowed or is only allowed from the user creating the object. In still another example embodiment of the present invention, access to the copied object is only allowed from specific host devices.

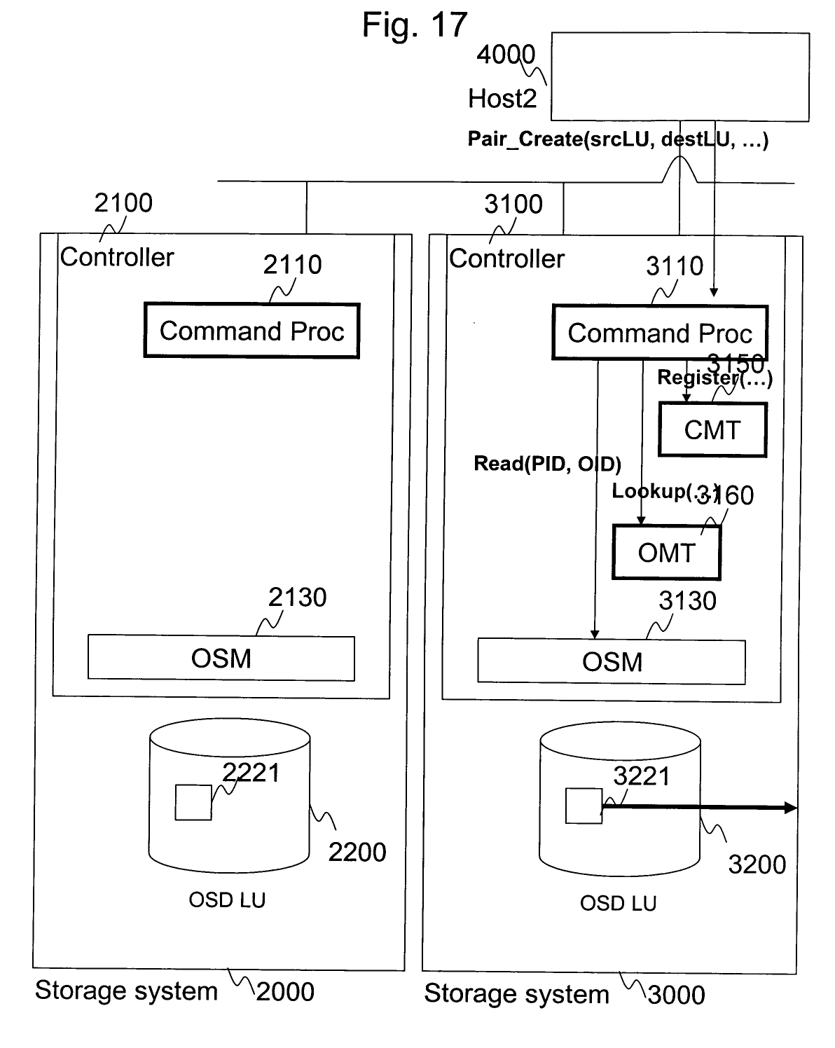

FIG. 17 shows a diagram of a system for logical unit based pair creation between secondary storage system and third storage system according to an example embodiment of the present invention. The system may include a first storage system 2000, and a second or remote storage system 3000. The first storage system 2000 includes a controller 2100 that includes a command processor module 2110. The storage system 2000 also includes one or more OSD logical units 2200, and an OSD storage manager (OSM) 2130. The OSD LU 2200 may include one or more objects 2221. The second storage system 3000 is similarly structured and includes a controller 3100 that includes a command processor module 3110, a copy management table 3150, and an object management table 3160. The second storage system 3000 also includes one or more OSD logical units 3200, and an OSM 3130. The OSD LU 3200 may include one or more objects 3221. This system architecture is similar to that shown previously in FIG. 13 except that it includes a second host device 4000 operatively connected to the remote storage system 3000. The command processor module 3110 of the remote storage system 3000 receives and operates commands (e.g., Pair_Create command containing appropriate parameters such as source LU, destination LU, etc.) from the host device 4000. The first storage system 2000 and the second storage system 3000 may be interconnected through their respective controllers 2100, 3100, via a network.

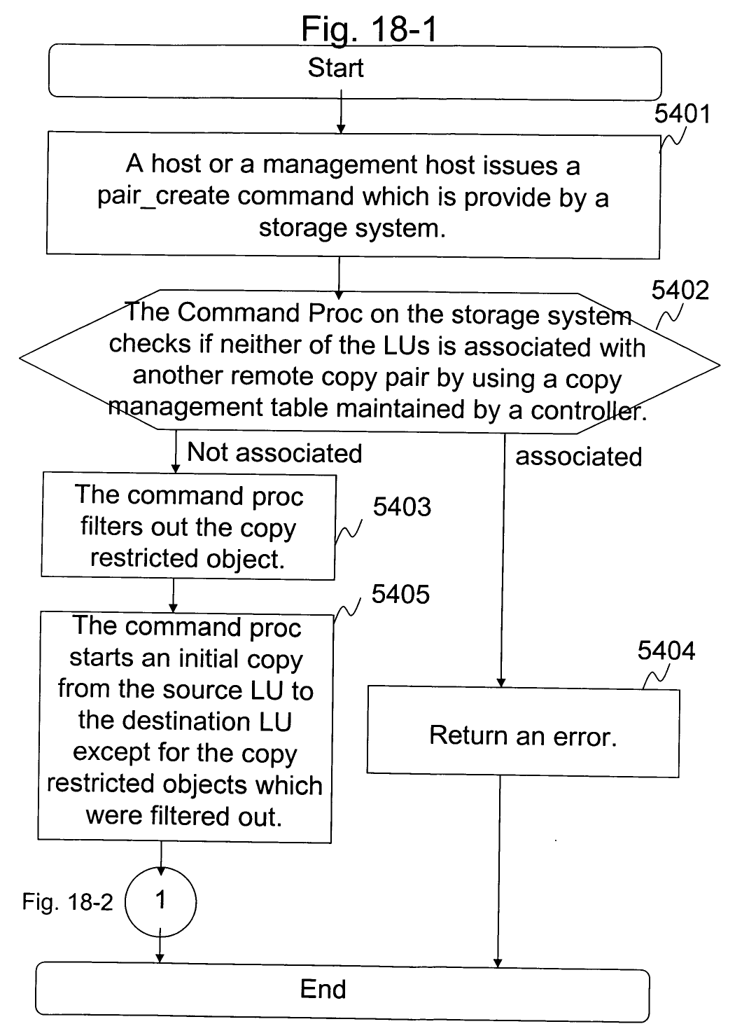

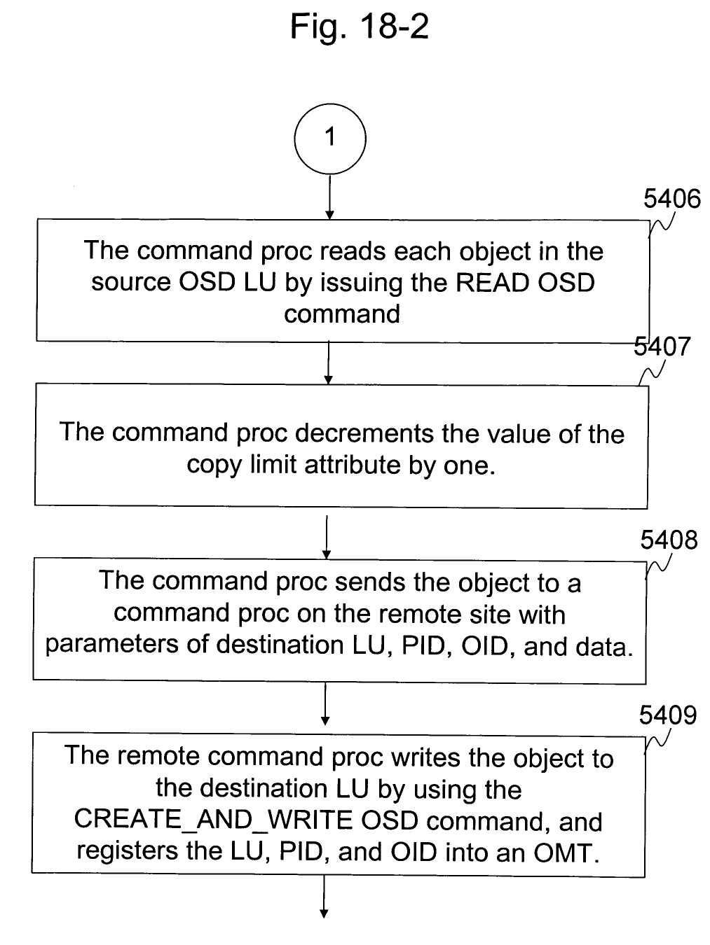

FIG. 18-1 and 18-2 show a flowchart for a process for logical unit based pair creation between secondary storage system and third storage system according to an example embodiment of the present invention. A host or a management host 4000 issues a pair_create command which is provided by a storage system (5401). The command processor module 3110 on the storage system 3000 checks to determine if either the source logical unit or the destination logical unit, identified in the pair_create command, are associated with another remote copy pair by using a copy management table 3150 maintained by a controller 3100 (5402). If either of the logical units have another association, an error message is returned to the host (5404). If neither of the logical units is associated with another remote copy pair, the command processor module filters out all copy restricted objects (i.e., eliminates objects where the value of the copy_limit equals 0 by using get_attribute OSD command denoting that no copies of the object may be generated, and saves the copy allowable objects' PID and OID in the memory of the controller 3100), (5403). The command processor module 3110 starts an initial copy from the source logical unit to the destination logical unit of the remaining copy allowable objects in the source logical unit, and does not copy the filtered objects (5405). The command processor module 3110 then reads each copy allowable object in the source OSD LU by issuing the read OSD command (5110). The command processor module 3110 decrements the value of the copy_limit attribute by one (5111), and then sends each copy allowable object to a command processor module on the third remote site with the parameters of destination LU, PID, OID, and data (5112). The remote command processor module on the third storage system write s each received object to the destination LU by using the create_and_write OSD command (5113).

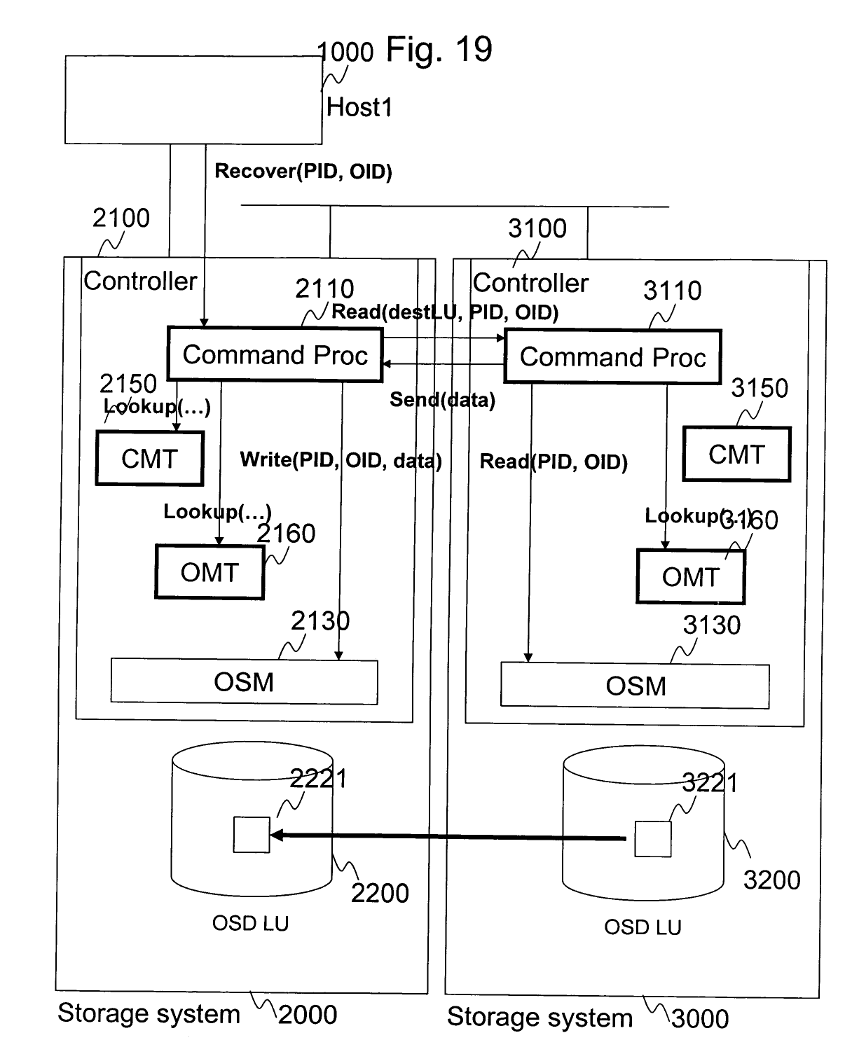

FIG. 19 shows a diagram of a system for object level recovery according to an example embodiment of the present invention. The system may include one or more host devices 1000, a first storage system 2000, and a second or remote storage system 3000. The first storage system 2000 includes a controller 2100 that includes a command processor module 2110, a copy management table 2150, and an object management table 2160. The storage system 2000 also includes one or more OSD logical units 2200, and an OSD storage manager (OSM)2130. The OSD LU 2200 may include one or more objects 2221. The second storage system 3000 is similarly structured and includes a controller 3100 that includes a command processor module 3110, a copy management table 3150, and an object management table 3160. The storage system 3000 also includes one or more OSD logical units 3200, and an OSM3130. The OSD LU 3200 may include one or more objects 3221. The command processor module 2110 of the first storage system 2000 receives and operates commands (e.g., Recover command containing parameters of PID and OID) from the host device 1000. The first storage system 2000 and the second storage system 3000 may be interconnected through their respective controllers 2100, 3100, via a network. The recovery of the copied object can be done by the unit of object or logical unit. The object level recovery process can be applied in situations where an object has been unintentionally deleted or destroyed. Further, a logical unit level recovery process (i.e., all objects in a logical unit), similar to the object level recovery process, can be applied in situations where the whole of a logical unit or a whole of the system has been destroyed.

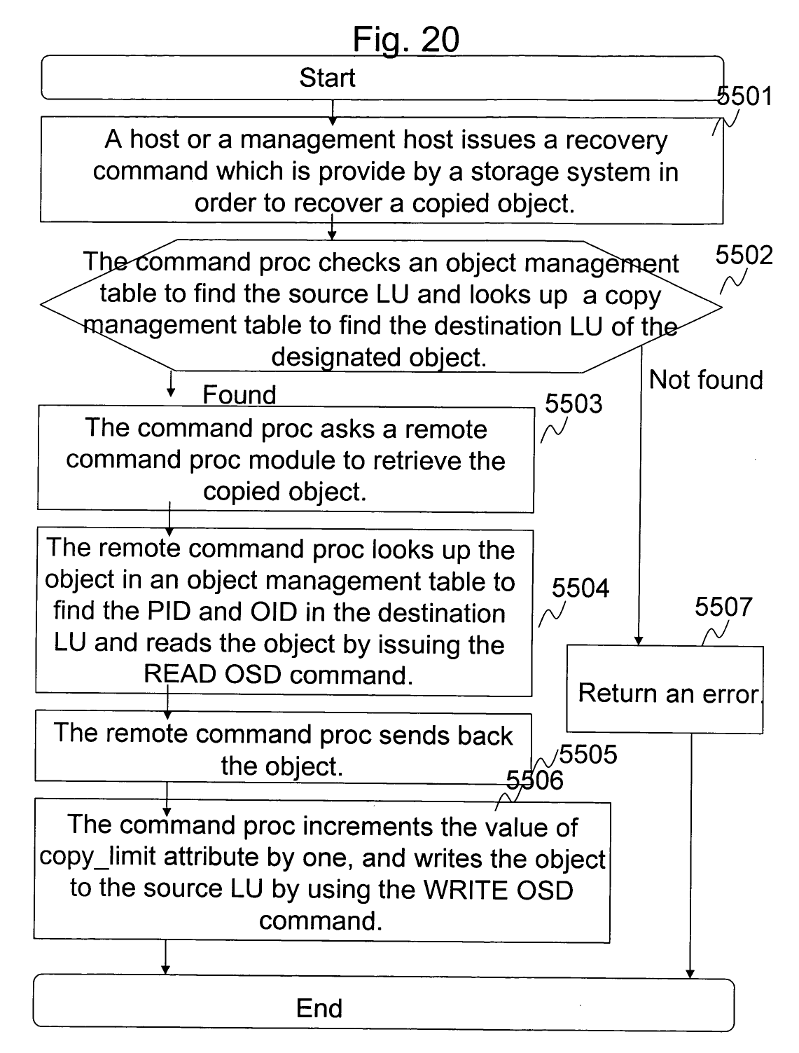

FIG. 20 shows a flowchart of a process for object level recovery according to an example embodiment of the present invention. A host or a management host 1000 issues a recovery command which is provided by a storage system 2000 in order to recover a copied object (5501). Typical parameters of the recovery command may be PID and OID. When the command processor 2110 on the storage system 2000 receives the recovery command, it checks an object management table 2160 maintained by a command processor 2110 to find the source LU and looks up a copy management table 2150 maintained by a command processor 2110 to find the destination LU of the designated object (5502). If the copied object in the remote storage system 3000 has the different PID and OID from those in the local storage system 2000, the object level copy management table (shown in FIG. 26) maintained by the command processor 2110 can be used to find the specific destination PID and OID. If the destination LU is found, the command processor module asks a remote command processor module 3110 to retrieve the copied object with parameters of destination LU, PID, and OID (5503). The remote command processor module 3110 looks up the object in the object management table 3160 to find the PID and OID in the destination LU and reads the object by issuing a read OSD command with parameters of PID and OID (5504). The remote command processor module 3110 then sends back the object to the command processor module 2110 (5505). The command processor module 2110 then increments the value of the copy_limit attribute by one and write s the object to the source logical unit by using the write OSD command (5506). If the destination LU is not found, an error message is returned to the host (5507).

The recovery command can be issued directly to the remote storage system 3000. In this case, when the command processor 3110 on the storage system 3000 receives the recovery command with parameters of PID and OID, it checks an object management table 2160 maintained by a command processor 3110 to find the destination LU and looks up a copy management table 3150 maintained by a controller 3100 to find the source LU of the designated object. If the copied object in the remote storage system 3000 has the different PID and OID from those in the local storage system 2000, the object level copy management table (shown in FIG. 26) maintained by the command processor 3110 can be used to find the specific source PID and OID. If the source LU is found, the command processor module 3100 reads the object by issuing a read OSD command. Then, the remote command processor module 3110 sends the object to the command processor module 2110. The command processor module 2110 then increments the value of copy_limit attribute by one and write s the object to the source logical unit by using the write OSD command.

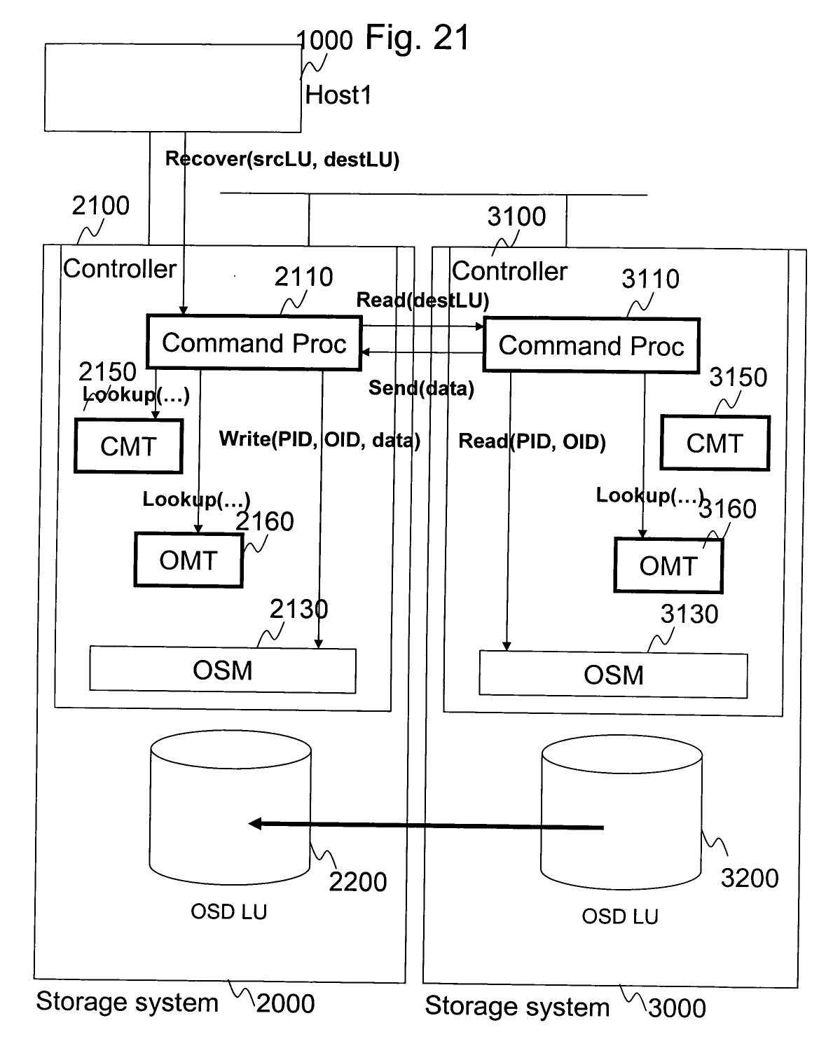

FIG. 21 shows a diagram of a system for a logical unit level recovery according to an example embodiment of the present invention. The system may include one or more host devices 1000, a first storage system 2000, and a second storage system 3000. The first storage system 2000 includes a controller 2100 that includes a command processor module 2110, a copy management table 2150, and an object management table 2160. The storage system 2000 also includes one or more OSD logical units 2200, and OSD storage manager (OSM) 2130. The second storage system 3000 is similarly structured and includes a controller 3100 that includes a command processor module 3110, a copy management table 3150, and an object management table 3160. The storage system 3000 also includes one or more OSD logical units 3200, and an OSM3130. The command processor module 2110 of the first storage system 2000 receives and operates commands (e.g., Recover command containing parameters of source LU and destination LU) from the host device 1000. The first storage system 2000 and the second storage system 3000 may be interconnected through their respective controllers 2100, 3100, via a network.

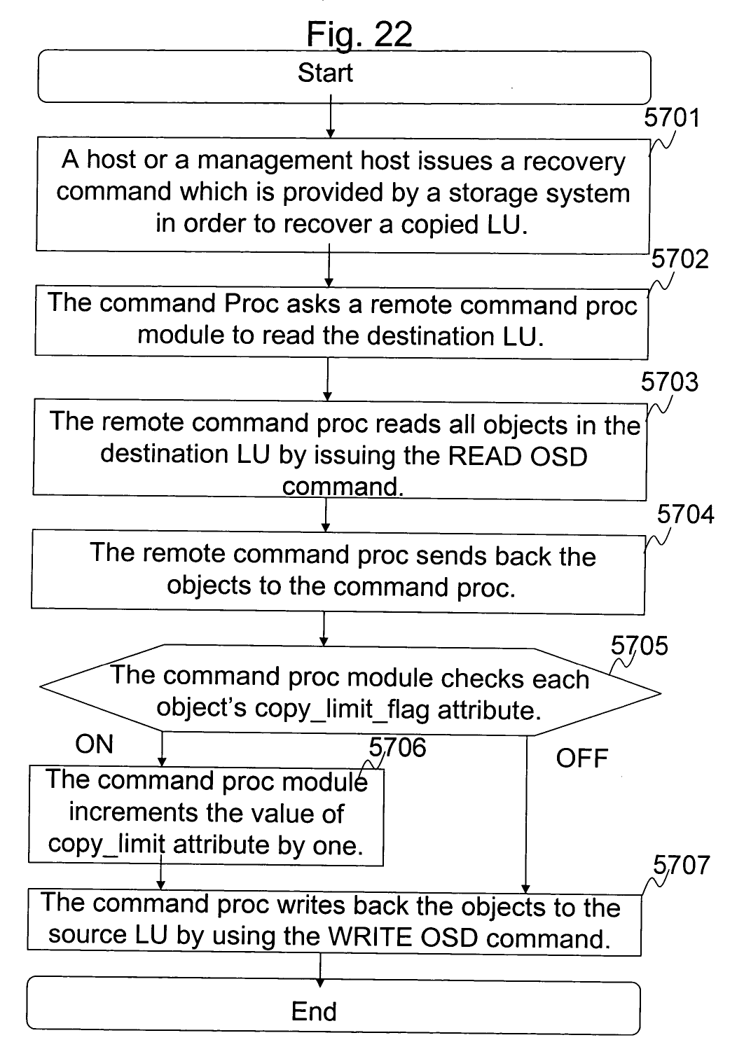

FIG. 22 shows a flowchart of a process for logical unit level recovery according to an example embodiment of the present invention. A host or a management host 1000 issues a recovery command provided by a storage system 2000 in order to recover a copied logical unit (5701). Typical parameters of a recovery command may include a source LU 2220 and a destination LU 3220. The parameter of destination LU can be an option. If the destination LU cannot be provided, the command processor module 2110 looks up a copy management table 2150 and finds the destination LU. When the command processor module 2110 on the storage system 2000 receives the recovery command, it asks a remote command processor module 3110 to read the destination LU 3220 (5702). The remote command processor module 3110 looks up the object management table 3160 to find PID and OID for all objects in the destination LU, and reads all objects in the destination LU by issuing the Read OSD command (5703). The command processor module 3110 then sends back the objects to the command processor module 2110 at the storage system (5704). Before the command processor module 2110 at the storage system write s back the objects to the source LU 2220 by using the write OSD command, it checks each object's copy_limit_flag attribute (5705). If the copy_limit_flag is “ON”, the copy processor module 2110 increments the value of the copy_limit attribute by one (5706). The command processor module 2110 then write s back the objects to the source LU by using the Write OSD command (5707). If the copy_limit_flag is “OFF”, step 5706 is skipped and the command processor module 2110 simply write s back the objects to the source LU by using the Write OSD command (5707).

The read, send, and write operations can be aggregated meaning therefore that it is possible to read multiple objects, send multiple objects, and write multiple objects. The LU level recovery command can be issued to the remote command processor module 3110. In this scenario, it is possible to remove the process step 5702 shown in FIG. 22. However, the command processor module sends the source LU as well as the read objects at the process step 5704.

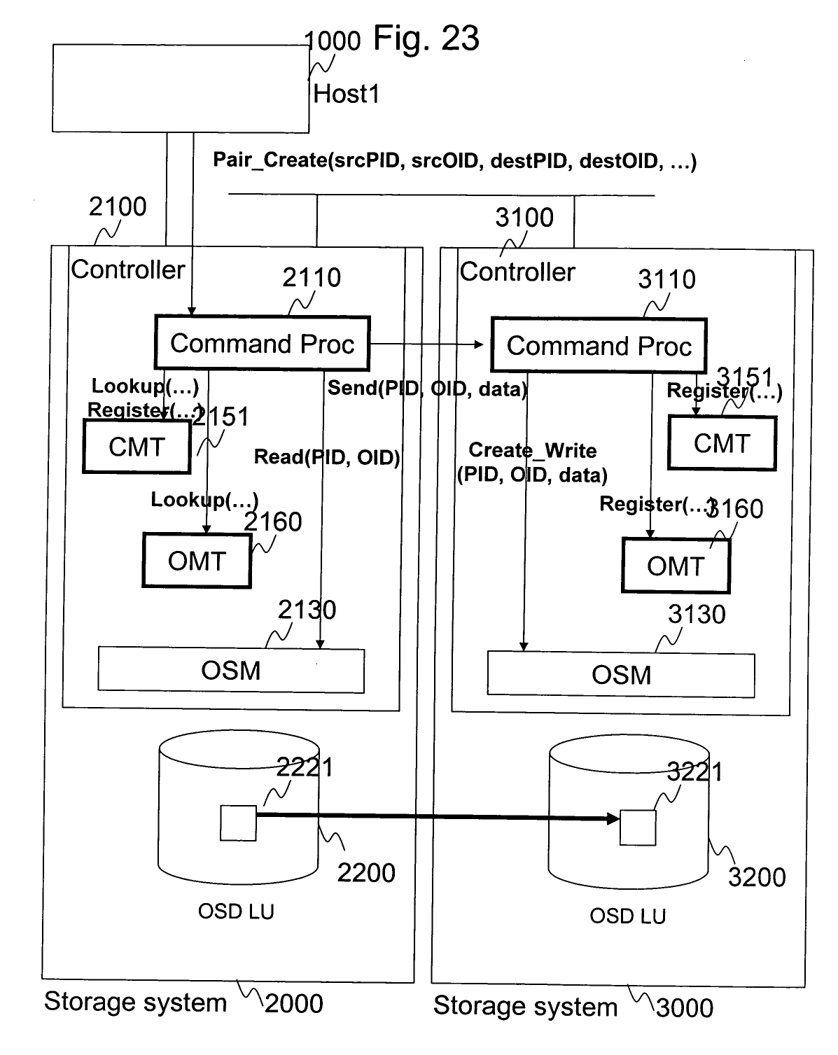

FIG. 23 shows a diagram of a system for object level remote copy pair creation according to an example embodiment of the present invention. In other embodiments of the present invention, the remote copy pair creation is done by the unit of storage of an OSD LU. The pair creation can also be done by the unit of an object. The process is similar to that of the LU level copy pair creation. The system may include one or more host devices 1000, a first storage system 2000, and a second or remote storage system 3000. The first storage system 2000 includes a controller 2100 that includes a command processor module 2110, an object level copy management table 2151 depicted in FIG. 26, and an object management table 2160. The storage system 2000 also includes one or more OSD logical units 2200, and OSD storage manager (OSM) 2130. The OSD LU 2200 may include one or more objects 2221. The second storage system 3000 is similarly structured and includes a controller 3100 that includes a command processor module 3110, an object level copy management table 3151, and an object management table 3160. The storage system 3000 also includes one or more OSD logical units 3200, and an OSM 3130. The OSD LU 3200 may include one or more objects 3221. The command processor module 2110 of the first storage system 2000 receives and operates commands (e.g., Pair_Create command containing appropriate parameters such as source PID, source OID, destination PID and destination OID, etc.) from the host device 1000. The first storage system 2000 and the second storage system 3000 may be interconnected through their respective controllers 2100, 3100, via a network.

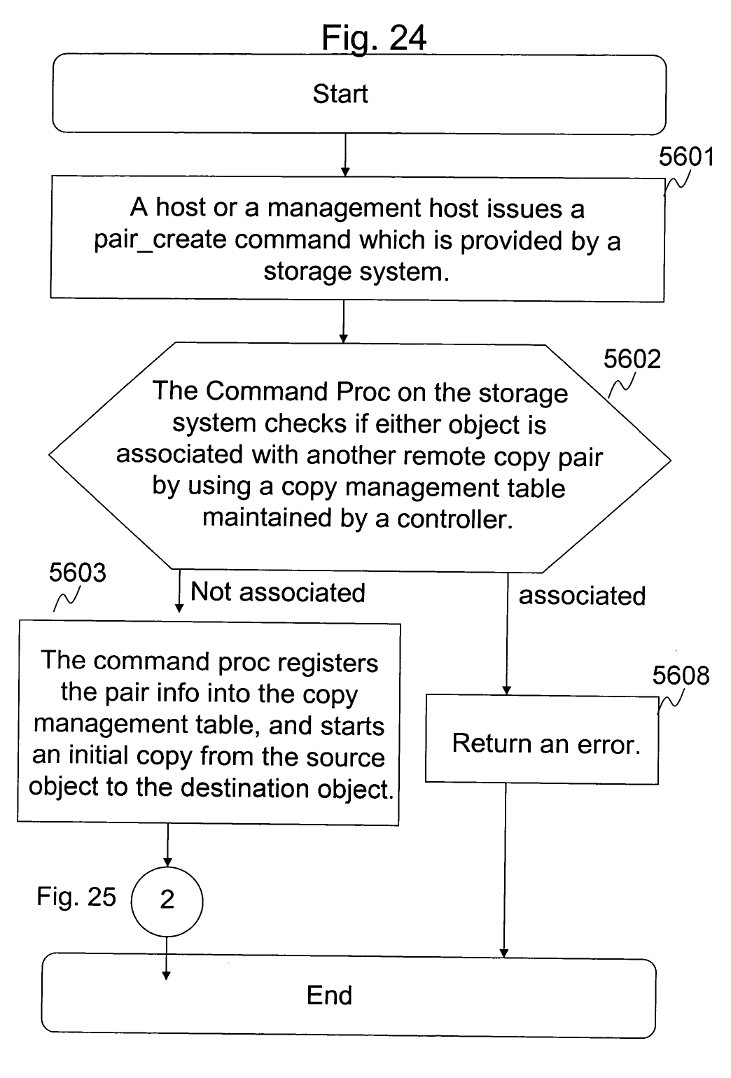

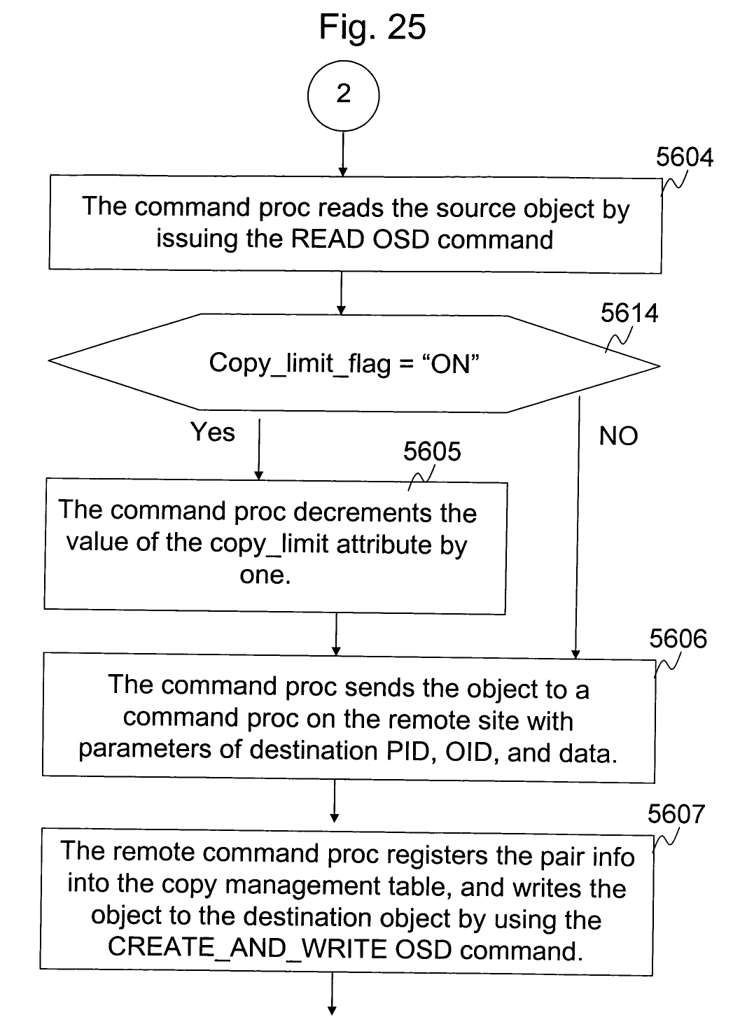

FIGS. 24 and 25 show a flowchart of a process for object level remote copy pair creation with copy limitation according to an example embodiment of the present invention. A host or a management host 1000 issues a pair_create command which is provided by a storage system 2000 in order to create a remote copy pair (5601). The typical parameters of the pair_create command are source PID and OID, and destination PID and OID. When the command processor module 2110 on the storage system 2000 receives the pair_create command, it checks to determine if either of the objects is associated with another remote copy pair by using an object level copy management table 2151 maintained by a controller 2100 (5602). If either of the objects is associated with another remote copy pair, an error message is sent to the host (5608). If the objects are not associated with another remote copy pair, the command processor module 2110 registers the pair information (e.g., source PID, source OID, destination PID, destination OID, status (Pair)) into the copy management table 2151, and starts an initial copy from the source object 2221 to the destination object 3221 at a remote storage system (5603). The command processor module 2110 reads the source object by issuing the read OSD command (5604). The command processor module 2110 then decrements the value of the copy_limit attribute by one if the copy_limit_flag is “ON” (5605) and sends the object to the command processor module 3110 on the remote site 3000 with parameters of destination PID, OID, and data (5606). The remote command processor module 3110 registers the pair information (e.g., source PID, source OID, destination PID, destination OID, status (Pair)) into the copy management table 2151, and then write s the object to the destination LU by using the create_and_write OSD command (5607). The destination PID and OID can be generated by the remote OSM module 3130 if they are not designated by the Pair_Create command. In this case, the generated PID and OID are sent back to the command processor 2110 from the command processor 3110.

FIG. 26 shows a diagram of an object level copy management table according to an example embodiment of the present invention. The table 2151 may include information related to source node, source PID and source OID, destination node, destination PID and destination OID, and status (e.g., pair, split). This table 2151 may be used by a storage system 2000 after it receives a pair_create command to check if either of the objects is associated with another remote copy pair, and is maintained by a command processor 2110 at the storage system 2000.

FIG. 27 shows a diagram of a system for logical unit level copy limitation setting according to an example embodiment of the present invention. The system may include one or more host devices 1000 and a storage system 2000. The storage system 2000 includes a controller 2100 that includes a command processor module 2110, and a copy management table 2150. The storage system 2000 also includes one or more OSD logical units 2200, and an OSD storage manager (OSM) 2130. The command processor module 2110 of the storage system 2000 receives and operates commands (e.g., copy_limit command containing parameters of LU and number of copies) from the host device 1000. In other embodiments, the copy limit setting was done by the unit of object. However, the copy limitation setting can also be done by the unit of OSD LU. The process is similar to that of the case of object level copy limit limitation setting.

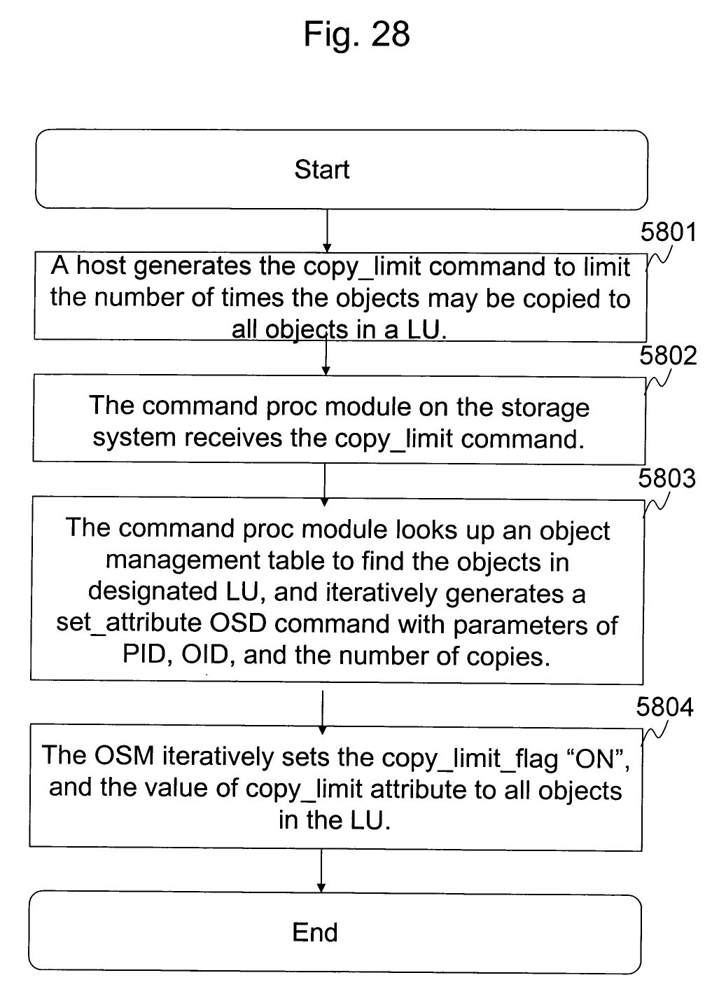

FIG. 28 shows a flowchart of a process for logical unit level copy limitation setting according to an example embodiment of the present invention. A host 1000 generates the copy_limit command to limit the number of times the objects may be copied to all objects in a specific OSD LU (5801). The command processor module 2110 on the storage system 2000 receives the copy_limit command (5802). The command processor module 2110 on the storage system 2000 looks up an object management table 2160 maintained by a command processor 2110 to find the objects (e.g., PID and OID) in designated LU, and then generates a set_attribute OSD command iteratively with parameters of PID, OID, and the number of copies (5803). Then, the OSM 2130 iteratively sets the copy_limit_(“ON”) and the value of the copy_limit attribute to all the objects in the OSD LU (5804).

It is noted that the foregoing examples have been provided merely for the purpose of explanation and are in no way to be construed as limiting of the present invention. While the present invention has been described with reference to a preferred embodiment, it is understood that the words that have been used herein are words of description and illustration, rather than words of limitation. Changes may be made within the purview of the appended claims, as presently stated and as amended, without departing from the scope and spirit of the present invention in its aspects. Although the present invention has been described herein with reference to particular methods, materials, and embodiments, the present invention is not intended to be limited to the particulars disclosed herein, rather, the present invention extends to all functionally equivalent structures, methods and uses, such as are within the scope of the appended claims.

What is claimed is:

1. A storage system for setting a copy limitation to an object, the storage system being operatively connected to a host and comprising:
a controller that includes a command processor module which processes commands from the host,
an object based storage device (OSD) having at least one logical unit (LU) that includes at least one object; and
an OSD storage manager (OSM) which manages said OSD in response to an output from said command processor,
wherein, in response to a copy command from the host, the command processor module reads each object to be copied from a source LU at the OSD via said OSM, checks a copy limit attribute of each object to be copied, prevents copying of the object if a value of the copy limit attribute is zero, and sends a copy of an object to a destination LU at a site for each object if the value of the copy limit attribute is greater than zero or non existent.

2. The storage system according to claim 1, wherein the site is one of a local site or a remote site.

3. The storage system according to claim 1, wherein the command processor module decrements by one the value of the copy limit attribute of each object sent to the site by at least one of the storage system or the site.

4. The storage system according to claim 1, wherein when the storage system receives a copy limit command from the host, the command processor module generates a set attribute OSD command that sets a copy limit flag and the value of the copy limit attribute of each said object, the copy limit attribute limiting the number of times the object that may be copied.

5. The storage system according to claim 4, wherein the copy limit command includes parameters comprising a partition ID of the object, an object ID of the object, and the number of allowable times of copies.

6. The storage system according to claim 1, wherein the command processor module, in response to a copy limit command, generates set attribute OSD commands with parameters of Partition Identifier (PID), Object Identifier (OID), and the number of copies in order to set a copy limit flag attribute and a value of the copy limit attribute, and
wherein the OSM processes the attribute OSD commands and sets the copy limit attribute and the copy limit flag attribute to the specific object.

7. The storage system according to claim 6, wherein the command processor generates the set attribute OSD commands based on a copy management table which stores copy pair information and an object management table which stores PIDs and OlDs in an OSD logical unit (LU).

8. A method in a storage system for setting a copy limitation to an object included in at least one logical unit (LU) of an object based storage device (OSD) of the storage system which is operatively connected to a host, said method comprising the steps of:
processing, by a command processor module of the storage system, commands from the host; and
managing, by an OSD storage manager (OSM), said OSD in response to an output from said command processor,
wherein said processing step includes:
in response to a copy command from the host, reading each object to be copied from a source LU at the OSD via said OSM,
checking a copy limit attribute of each object to be copied,
preventing copying of the object if a value of the copy limit attribute is zero, and
sending a copy of an object to a destination LU at a site for each object if the value of the copy limit attribute is greater than zero or non existent.

9. The method according to claim 8, wherein the site is one of a local site or a remote site.

10. The method according to claim 8, wherein the command processor module decrements by one the value of the copy limit attribute of each object sent to the site by at least one of the storage system or the site.

11. The method according to claim 8, wherein said processing step further includes:
when the storage system receives a copy limit command from the host, generating a set attribute OSD command that sets a copy limit flag and the value of the copy limit attribute of each said object, the copy limit attribute limiting the number of times the object that may be copied.

12. The method according to claim 11, wherein the copy limit command includes parameters comprising a partition ID of the object, an object ID of the object, and the number of allowable times of copies.

13. The method according to claim 8, wherein the processing step further includes:
in response to a copy limit command, generating set attribute OSD commands with parameters of Partition Identifier (PID), Object Identifier (OID), and the number of copies in order to set a copy limit flag attribute and a value of the copy limit attribute, and
processing, by the OSM, the attribute OSD commands and setting the copy limit attribute and the copy limit flag attribute to the specific object.

14. The method according to claim 13, wherein said generating step includes:
generating the set attribute OSD commands based on a copy management table which stores copy pair information and an object management table which stores PIDs and OlDs in an OSD logical unit (LU).

15. The method according to claim 13, wherein the copy limit command sets a limit of the number of copies of all objects in a logical unit that may be generated.

16. The method according to claim 13, wherein the copy limit command includes parameters of PID, OID, and said number of copies.

17. The method according to claim 8, wherein when the command processor module receives a pair create command to create a remote copy pair, the processing includes:
checking, by the command processor module, if either a source unit or a destination unit, from the pair create command, are associated with another remote copy pair, and
copying from the source unit to the destination unit, by the command processor module, if neither said source unit or said destination unit are associated with another remote copy pair.

18. The method according to claim 17, wherein the copying comprises:
reading, by the command processor module, the source unit;
decrementing by one a value of a copy limit attribute of said source unit;
sending, by the command processor module, a copy of said source unit to a second command processor module at a remote site; and
writing said copy to the destination unit at the remote site by the second command processor module.

19. The method according to claim 18, wherein the decrementing being performed by at least one of the storage system or the remote site.

20. The method according to claim 17, wherein each of the source and destination unit comprises an object, and
wherein the pair create command includes parameters of a source partition ID, a source object ID, a destination partition ID, and a destination object ID.

21. The method according to claim 17, wherein each of the source and destination unit comprises an object in each logical unit (LU), and
wherein the pair create command including parameters of a source logical unit and a destination logical unit, the destination logical unit being at a remote site.

22. The method according to claim 17, wherein the checking comprises checking a copy management table.

23. The method according to claim 22, wherein the copy management table is maintained by a controller at the storage system and includes information regarding at least one of source node, source logical unit, destination node, destination logical unit, and status.

24. The method according to claim 17, further comprising:
managing object IDs in a logical unit by the command processor module using an object management table, the object management table including information regarding at least one of logical unit, partition ID and object ID.

25. The method according to claim 24, wherein the object management table is located in an external metadata server.

26. The method according to claim 18, wherein each of said source and destination unit is sent with parameters of destination LU, partition ID, object ID, and data.

27. The method according to claim 18, further comprising writing each said copy using a create and write OSD command.

28. The method according to claim 18, wherein the reading, the sending, and the writing are aggregated making it possible to read multiple units, send multiple units and write multiple units.

29. The method according to claim 18, further comprising:
filtering out units where the value of the copy limit attribute equals zero and performing the copying of units from the source unit to the destination unit only for units where the value of the copy limit attribute is greater than zero or non existent.

30. The method according to claim 8, wherein when command processor module at a remote storage system receives a read command form the host to read an object, processing at the remote storage system includes:
checking a value of a copy limit attribute of the object by the command processor module;
determining if the value of the copy limit attribute is larger than zero or not designated; and
issuing, by the command processor module at the remote storage system, a read OSD command to a dispatcher of object storage at the remote storage system, if the value of the copy limit attribute is larger than zero or not designated.

31. The method according to claim 30, wherein the checking comprises generating a get attribute OSD command.

32. The method according to claim 30, further comprising:
rejecting the read command if the value of the copy limit attribute is zero.

33. The method according to claim 30, further comprising:
allowing access to the object if the read command is from a user who created the object even if the value of the copy limit attribute is zero.

34. The method according to claim 30, further comprising:
allowing access to the object if the read command is from a specific host device even if the value of the copy limit attribute is zero.

35. The method according to claim 8, wherein when the command processor module receives a recovery command for a designated unit in order to recover a copied unit, the processing includes:
checking to find a destination logical unit (LU) of the designated unit at the storage system;
requesting by the processor module to a remote processor module at a remote storage system to retrieve the copied unit, if the destination LU is found;
reading by the remote processor module the designated unit;
transferring the read designated unit by the remote processor module to the processor module;
incrementing by one a value of a copy limit attribute of the designated unit by the processor module; and
writing the designated unit to a source logical unit at the storage system.

36. The method according to claim 35, wherein the recovery command comprises parameters of partition ID (PID) and object ID (OID).

37. The method according to claim 36, wherein the checking comprises checking a copy management table maintained by a controller at the storage system to find the destination LU of the designated unit.

38. The method according to claim 36, wherein the reading by the remote processor module of the designated unit includes issuing a read OSD command.

39. The method according to claim 36, further comprising:
writing the designated unit to the source logical unit using a write OSD command.

40. The method according to claim 36, wherein the recovery command is issued from one of a host attached to the storage system or a host attached to the remote storage system.

41. The method according to claim 35, wherein the unit comprises one of an object or each object in a logical unit.
